(19) United States
(12) Patent Application Publication
(10) Pub. No.: US 2013/0346178 A1
(43) Pub. Date: Dec. 26, 2013

(54) METHOD AND SYSTEM FOR PROVIDING COUPON IN CONNECTION WITH SOCIAL NETWORKING SERVICE

(71) Applicant: Jaeseok CHOI, Daegu (KR)

(72) Inventor: Jaeseok CHOI, Daegu (KR)

(73) Assignee: ITH CORPORATION, Seoul (KR)

(21) Appl. No.: 13/530,535

(22) Filed: Jun. 22, 2012

(51) Int. Cl. G06Q 30/02

(52) U.S. Cl. 705/14.26

(57) ABSTRACT

A method and system for providing a coupon in connection with Social Networking Service (SNS), the method includes transmitting a coupon guide page including coupon guide information to a user terminal through a transceiver of a service server by a page manager, providing a mission completion input page for a mission to the user terminal by a mission completion input page provider, when the user terminal transmits an authorization grant signal to an SNS management server operating the SNS, the authorization grant signal granting the service server with authority for an SNS account to which a user logs in, receiving mission completion information input to the mission completion input page from the user terminal by the transceiver of the service server, and transmitting a coupon corresponding to the coupon guide information to the user terminal through the transceiver of the service server by a coupon provider of the service server.

### BACKGROUND OF THE INVENTION

1. Field of the Invention

The present invention relates to a method and system for providing a coupon in connection with Social Networking Service (SNS), and more particularly, to a method and system for providing a coupon in connection with SNS, in which once a user fulfills a mission offered on a coupon guide page, a mobile coupon is provided to a user device.

2. Discussion of the Related Art

A coupon issuing system for now popular social commerce is run in such a manner that when a user purchases a specific product or service (e.g. food or beauty service) at a discount price, the user prints or downloads a coupon for the product or service and presents the coupon to an offline shop to receive the product or service.

In the case where a customer purchases a product or service whose quality has been verified through such a coupon issuing system, the coupon issuing system is helpful to the customer. On the other hand, if a customer relies on unreliable information such as reviews on a social commerce site or a blog for his or her purchase, it may be difficult to guarantee the reliability of the product or service.

In this context, if persons among whom a “social relationship” has been established actively recommend a specific product or service to one another on an SNS site such as Facebook or Twitter, the reliability of the product or service can be increased.

However, an efficient system is yet to be built to induce a person to recommend a specific product or service to others with which the person has a “social relationship”.

### SUMMARY OF THE INVENTION

Accordingly, the present invention is directed to a method and system for providing a coupon in connection with Social Networking Service (SNS) that substantially obviate one or more problems due to limitations and disadvantages of the related art.

An object of the present invention is to provide a system and method for providing a coupon in connection with SNS, which can enable effective exchange between a recommendation activity of a person in a “social relationship” and the value of a coupon.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages in accordance with the purpose of the invention, as embodied and broadly described herein, a method for providing a coupon in connection with Social Networking Service (SNS), includes transmitting a coupon guide page including coupon guide information to a user terminal through a transceiver of a service server by a page manager of the service server, providing a mission completion input page for a mission to the user terminal by a mission completion input page provider of the service server, when the user terminal transmits an authorization grant signal to an SNS management server that operates the SNS, the authorization grant signal granting an authority for an SNS account to which a user logs in to the service server, receiving mission completion information input to the mission completion input page from the user terminal by the transceiver of the service server, and transmitting a coupon corresponding to the coupon guide information to the user terminal through the transceiver of the service server by a coupon provider of the service server.

The coupon guide information may include mission information and coupon type information.

The mission completion information may include image information.

The method may further include receiving coupon setting information from a manager terminal by the transceiver of the service server, generating the coupon guide page based on the coupon setting information by the page manager of the service server, and storing the coupon guide page in a memory of the service server by the page manager of the service server.

The coupon setting information may include mission information, coupon type information, and period of issuing information.

In another aspect of the present invention, there is provided a method for providing a coupon in connection with Social Networking Service (SNS), the method including receiving a coupon guide page including coupon guide information from a service server by a transceiver of a user terminal, transmitting an authorization grant signal to an SNS management server that operates the SNS by the transceiver of the user terminal, the authorization grant signal granting an authority for an SNS account to which a user logs in to the service server, receiving a mission completion input page from the service server by the transceiver of the user terminal, transmitting, upon receipt of mission completion information on the mission completion input page, the mission completion information to the service server and the SNS management server through the transceiver of the user terminal by a processor of the user terminal, and receiving a coupon corresponding to the coupon guide information from the service server by the transceiver of the user terminal.

The coupon guide information may include mission information and coupon type information.

The mission completion information may include image information.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 illustrates the configuration of a system for providing a coupon in connection with Social Networking Service (SNS) according to an embodiment of the present invention;

FIG. 2 is a block diagram of a service server according to an embodiment of the present invention;

FIG. 3 is a block diagram of a device applicable to a user terminal according to an embodiment of the present invention;

FIG. 4 is a flowchart illustrating a method for providing a coupon in connection with SNS according to an embodiment of the present invention; and

FIG. 5 illustrates an exemplary case where the method for providing a coupon in connection with SNS according to the embodiment of the present invention is performed in a user terminal.

### DETAILED DESCRIPTION OF THE INVENTION

The objectives and effects of the present invention and the technical configurations of the present invention to achieve them will be apparent with reference to embodiments of the present invention described in detail with the attached drawings. A detailed description of a generally known function and structure of the present invention will be avoided lest it should obscure the subject matter of the present invention. Although the terms used in the present invention are selected from generally known and used terms, taking into account the structures, roles, and functions of the present invention, they are subject to change depending on the intention of a user or an operator or practices.

It is to be clearly understood that the present invention may be implemented in various manners, not limited to embodiments as set forth herein. The embodiments of the present invention are provided only to render the disclosure of the present invention comprehensive and indicate the scope of the present invention to those skilled in the art. The present invention is defined only by the appended claims. Accordingly, the scope of the invention should be determined by the overall description of the specification.

Through the specification, when it is said that some part “includes” a specific element, this means that the part may further include other elements, not excluding them, unless otherwise mentioned. The term “-er(or)”, “module”, “unit” or “part” is used to signify a unit of performing at least one function or operation. The unit can be realized in hardware, software, or in combination of both.

Meanwhile, in the embodiments of the present invention, each component, function block, or device may be configured with one or more lower-layer components and its electrical, electronic and mechanical functions can be implemented with various known devices or mechanical components such as an electronic circuit, an integrated circuit, an Application Specific Integrated Circuit (ASIC), etc. Each component may be separately configured or two or more components may be incorporated into a single component.

It will be understood that each block and combinations of blocks of the attached flowchart and/or block diagram illustrations may be implemented by computer program instructions. These computer program instructions may be loaded onto a processor of a general-purpose computer, a special-purpose computer, or other programmable data processing apparatus, such that the instructions, which are executed via the processor of the computer or other programmable data processing apparatus, create means for implementing the functions specified in the flowchart and/or block diagram block or blocks. These computer program instructions may also be stored in a computer-usable or computer-readable memory that may direct a computer or other programmable data processing apparatus to function in a particular manner, such that the instructions executed in the computer-usable or computer-readable memory produce an article of manufacture including instructions that implement the function specified in the flowchart and/or block diagram block or blocks. The computer program instructions may also be loaded onto a computer or other programmable data processing apparatus to cause a series of operational steps to be performed on the computer or other programmable data processing apparatus to produce a computer implemented process such that the instructions that are executed on the computer or other programmable data processing apparatus provide steps for implementing the functions specified in the flowchart and/or block diagram block or blocks.

Each block or step may represent a module, a segment, or a portion of code, which may comprise one or more executable instructions for implementing a specified logical function or functions. It should also be noted that in some alternative embodiments, the functions noted in the blocks or steps occur out of the order. For example, two blocks or steps shown in succession may, in fact, be executed substantially concurrently or the blocks or steps may be sometimes executed in the reverse order, depending on the functionality involved.

Now a description will be given of a method and system for providing a coupon in connection with Social Networking Service (SNS) according to an embodiment of the present invention.

According to the present invention, SNS refers to a service which enables users to establish a social relationship among them over the Internet, such as Facebook or Twitter.

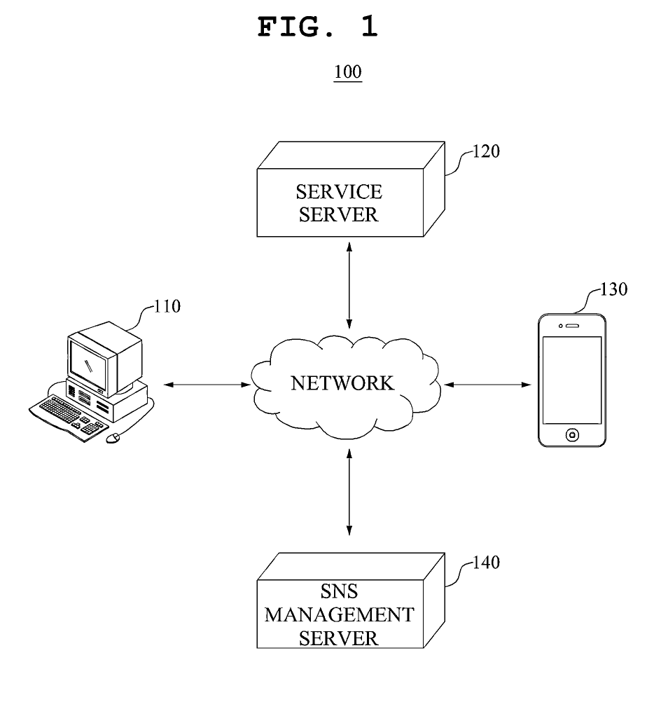

FIG. 1 illustrates the configuration of a system for providing a coupon in connection with SNS according to an embodiment of the present invention. Referring to FIG. 1, a coupon providing system 100 includes a manager terminal 110, a service server 120 for providing a coupon providing service according to an embodiment of the present invention, a user terminal 130, and an SNS management server 140 for operating the SNS. The manager terminal 110, the service server 120, the user terminal 130, and the SNS management server 140 are connected to one another via a network. The network includes a wired or wireless network over which data can be transmitted.

The manager terminal 110 covers a desktop PC and a mobile device like a Personal Digital Assistant (PDA), a smart phone, or a table PC. The user terminal 130 covers a mobile device like a PDA, a smart phone, or a table PC.

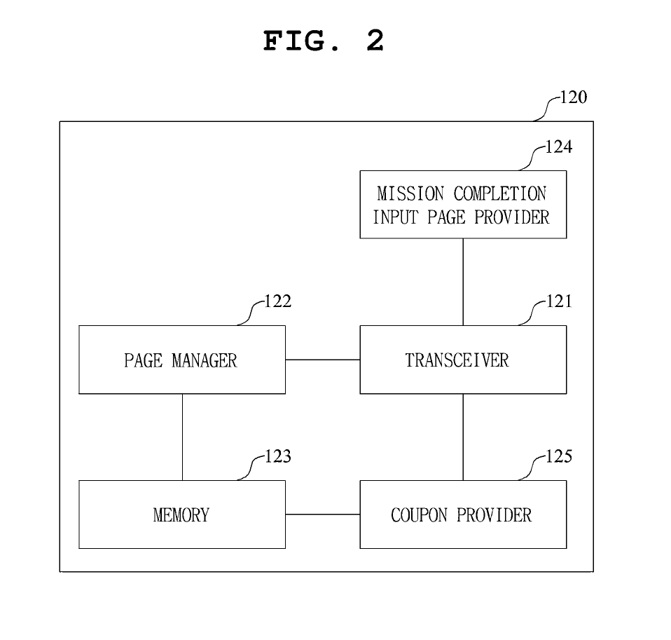

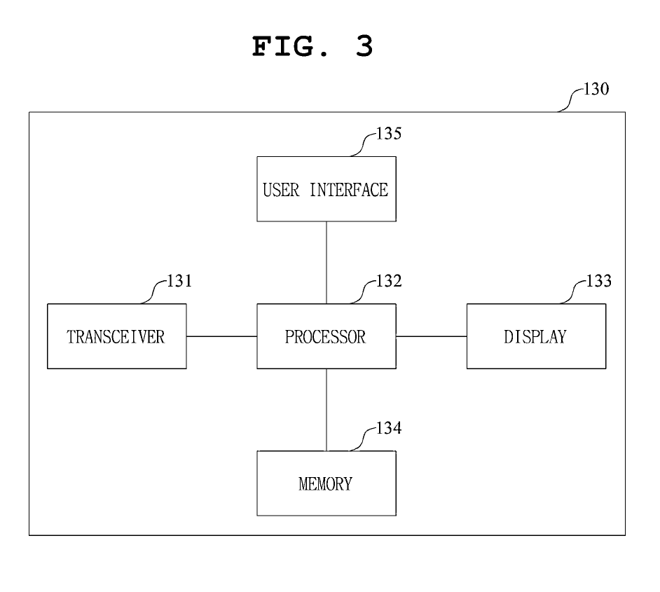

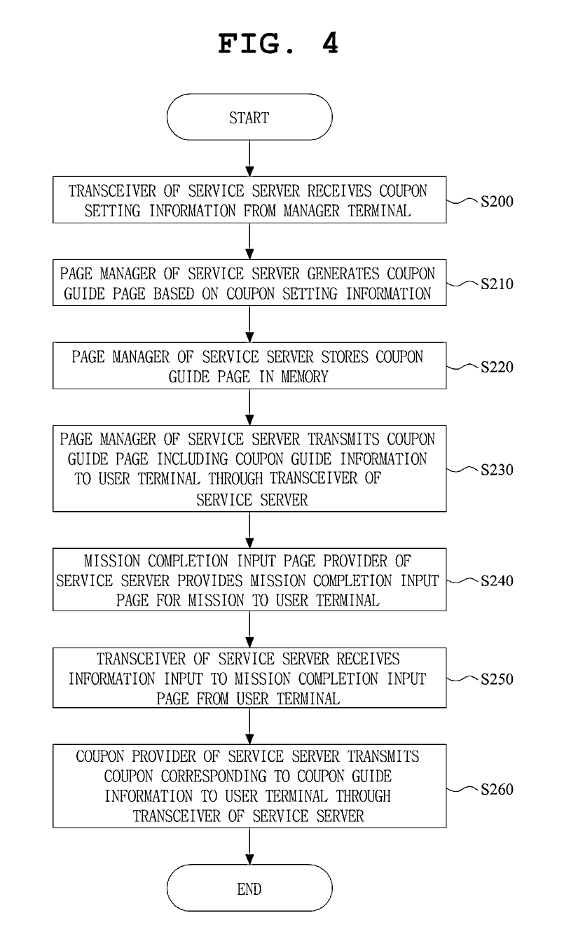

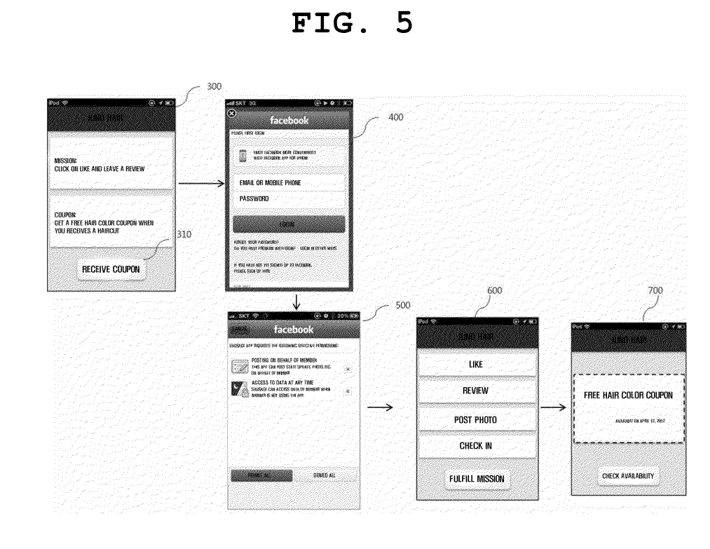

FIG. 2 is a block diagram of the service server 120 according to an embodiment of the present invention and FIG. 3 is a block diagram of a device applicable to the user terminal 130 according to an embodiment of the present invention. FIG. 4 is a flowchart illustrating a method for providing a coupon in connection with SNS according to an embodiment of the present invention and FIG. 5 illustrates an exemplary case where the method for providing a coupon in connection with SNS according to the embodiment of the present invention is performed in a user terminal.

The device applicable to the user terminal 130 includes a transceiver 131, a processor 132, a display 133, a memory 134, and a user interface 135. A physical interface protocol layer is implemented in the processor 132. The processor 132 provides a control plane and a user plane. The functionality of each layer may be implemented in the processor 132. The memory 134 is electrically connected to the processor 132 and stores an Operating System (OS), applications, and general files. The display 133 may display various types of information and may be configured with a known Liquid Crystal Display (LCD), Organic Light Emitting Diode (OLED), etc. The user interface 135 may be configured with known user interfaces such as a keypad, a touch screen, etc. in combination. The display 133 and the user interface 135 may be integrated into a touch screen. The transceiver 131 is electrically connected to the processor 132 and transmits or receives a signal wirelessly.

With reference to FIGS. 2 to 5, a detailed description will be given of a method for providing a coupon in connection with SNS according to an embodiment of the present invention.

A transceiver 121 of the service server 120 receives coupon setting information from the manager terminal 110 (S200). The service server 120 may provide an interface through which a manager can access a manager page through the manager terminal 110 and set coupon setting information. The coupon setting information specifies the contents and duration of a coupon that the manager intends to issue, including mission information, coupon type information, and period of issuing information.

The period of issuing information specifies a period of issuing a coupon that is to be offered when a mission defined in the mission information is fulfilled. For example, the manager may set the period of issuing to any time period such as 1 or 2 weeks, or 1 month. To indicate the period of issuing, it is also possible to set the starting and ending days of issuing a coupon.

The mission information may define a manager-set mission such as “Write a review”, “Click on Like”, “Check in current location”, “Leave a review with a photo”, or “Tag a friend along”. The coupon type information provides information about the contents of the coupon. For instance, the coupon type information may be discount coupon information such as “10% off the purchase price” or free coupon information such as “a free hair color coupon when you receive a haircut”. The manager may freely set a coupon type as intended.

The mission may be preset, taking into account functions supported by the SNS. The manager may access a manager page of a coupon issuing service run by the service server 120 of the present invention through the manager terminal 110 and select a desired mission from among available missions on the manager page.

A page manager 122 of the service server 120 generates a coupon guide page based on the coupon setting information (S210) and stores the coupon guide page in a memory 123 of the service server 120 (S220).

Then the user accesses an address of the coupon guide page through the user terminal 120. The address of the coupon guide page may be accessed in various manners. For example, the user may directly enter the address of the coupon guide page on the user terminal 130 or may scan a Quick Response (QR) code of the coupon guide page available in an offline shop with the user terminal 130 and access the address of the coupon guide page based on the scanned QR code. The coupon guide page may be linked to a connection page for Wireless Fidelity (WiFi) service provided by the offline shop. The address of the coupon guide page may be generated per offline shop and may be offline shop-specific.

When the user accesses the address of the coupon guide page using the access terminal 130, the page manager 122 of the service server 120 transmits the coupon guide page including coupon guide information to the user terminal 130 through the transceiver 121 (S230).

The coupon guide information includes the mission information and the coupon type information.

Referring to FIG. 5, for example, a coupon guide page 300 may include “Click on Like and leave a Review” as mission information and “Get a coupon for a free hair color when you receives a haircut” as coupon type information.

When the user selects a Receive Coupon menu 310 on the coupon guide page 300 in FIG. 5, the user may be connected to an SNS login page 400. If the user has already logged in to an SNS site using the user terminal 130, the connection to the login page 400 may be omitted.

Once the user logs in to the SNS login page 400 using the user terminal 130 or when the user has already logged in to the SNS site, the SNS management server 140 transmits an authorization request message to the user terminal 130 to ask whether to authorize the service server 120 for an SNS account to which the user has logged in.

When the authorization request message is displayed on the display 133 of the user terminal 130 and the user selects a menu that grants an authority in the authorization request message, the transceiver 131 of the user terminal 130 transmits to the SNS management server 140 an authorization grant signal that grants the service server 120 with an authority for the SNS account.

The authorization request message may be a message requesting that the service server 120 is allowed to post on behalf of the SNS account to which the user has logged in for the SNS or the service server 120 is allowed to access personal information associated with the SNS account. If posting is allowed on behalf of the SNS account, the user may post a review to a page provided by the service server 130 and register it to the SNS.

As illustrated in FIG. 5, a page 500 including an authorization request message may be transmitted to the user terminal 130 and may be displayed on the display 133 of the user terminal 130.

When the SNS management server 140 receives the authorization grant signal, the service server 130 is authorized for the SNS account and a mission completion input page provider 124 of the service server 120 provides a mission completion input page to the user terminal 130 so that the user may fulfill a mission (S240). The mission completion input page is provided to the user to indicate a mission that the user is supposed to fulfill to receive a coupon.

For example, a mission completion input message 600 may include a “Like” button for recommendation, a “Review” menu for writing a review, a “Post Photo” menu for posting a photo”, and a “Check In” menu. The mission completion input page 600 may be configured in a manner that activates the “Review” menu and the “Post Photo” menu only when the “Like” button is selected.

When the user inputs information to the mission completion input message to fulfill a mission through the user interface 131 of the user terminal 130, the input information is transmitted to the service server 120 and the SNS management server 140 that operates the SNS.

When the transceiver 121 of the service server 120 receives the information input to the mission completion input page from the user terminal 130 (S250), a coupon provider 125 of the service server 120 determines whether the user has fulfilled the mission based on the received information.

Then, if determining that the user has fulfilled the mission, the coupon provider 125 retrieves a coupon corresponding to the coupon guide information from the memory 123 and transmits the coupon to the user terminal 130 through the transceiver 121 (S260).

Upon receipt of the coupon at the transceiver 131 of the user terminal 130, the processor 132 displays the coupon on the display 133 and stores the coupon in the memory 134.

As illustrated in FIG. 5, a free hair color coupon 700 may be transmitted to the user terminal 130.

As is apparent from the above description of the method and system for providing a coupon in connection with SNS according to the embodiment of the present invention, since an SNS subscriber is induced to post information about a specific product or service to an SNS site, the specific product or service can be actively recommended and its reliability can be increased.

In addition, since a coupon is provided to a person that has posted a review about the specific product or service to the SNS site, a “social relationship” established through SNS may be extended to purchase of a product or service in an offline shop.

The method for providing a coupon in connection with SNS according to the embodiment of the present invention may be written as a program that can be executed by a computer and may be implemented in a general-purpose digital computer that can execute the program using a computer-readable recording medium. Examples of the computer-readable recording medium include a magnetic storage medium such as a ROM, a floppy disk, and a hard disk, an optical readable medium such as a CD ROM and a DVD, and a storage medium such as a carrier wave (e.g., data transmission over the Internet).

Those skilled in the art will appreciate that the present invention may be carried out in other specific ways than those set forth herein without departing from the spirit and essential characteristics of the present invention. The above embodiments are therefore to be construed in all aspects as illustrative and not restrictive. The scope of the invention should be determined by the appended claims and their legal equivalents, not by the above description, and all changes coming within the meaning and equivalency range of the appended claims are intended to be embraced therein.

What is claimed is:

1. A method for providing a coupon in connection with Social Networking Service (SNS), the method comprising:
transmitting a coupon guide page including coupon guide information to a user terminal through a transceiver of a service server by a page manager of the service server;
providing a mission completion input page for a mission to the user terminal by a mission completion input page provider of the service server, when the user terminal transmits an authorization grant signal to an SNS management server that operates the SNS, the authorization grant signal granting an authority for an SNS account to which a user logs in to the service server;
receiving mission completion information input to the mission completion input page from the user terminal by the transceiver of the service server; and
transmitting a coupon corresponding to the coupon guide information to the user terminal through the transceiver of the service server by a coupon provider of the service server.

2. The method according to claim 1, wherein the coupon guide information includes mission information and coupon type information.

3. The method according to claim 1, wherein the mission completion information includes image information.

4. The method according to claim 1, further comprising:
receiving coupon setting information from a manager terminal by the transceiver of the service server;
generating the coupon guide page based on the coupon setting information by the page manager of the service server; and
storing the coupon guide page in a memory of the service server by the page manager of the service server.

5. The method according to claim 4, wherein the coupon setting information includes mission information, coupon type information, and period of issuing information.

6. A computer-readable recording medium to which the method according to claim 1 is programmed.

7. A method for providing a coupon in connection with Social Networking Service (SNS), the method comprising:
receiving a coupon guide page including coupon guide information from a service server by a transceiver of a user terminal;
transmitting an authorization grant signal to an SNS management server that operates the SNS by the transceiver of the user terminal, the authorization grant signal granting an authority for an SNS account to which a user logs in to the service server;
receiving a mission completion input page from the service server by the transceiver of the user terminal;
transmitting, upon receipt of mission completion information on the mission completion input page, the mission completion information to the service server and the SNS management server through the transceiver of the user terminal by a processor of the user terminal; and
receiving a coupon corresponding to the coupon guide information from the service server by the transceiver of the user terminal.

8. The method according to claim 7, wherein the coupon guide information includes mission information and coupon type information.

9. The method according to claim 7, wherein the mission completion information includes image information.

10. A computer-readable recording medium to which the method according to claim 7 is programmed.
